(19) United States
(12) Patent Application Publication
(10) Pub. No.: US 2017/0352509 A1
(43) Pub. Date: Dec. 7, 2017

(54) HIGH-VOLTAGE ELECTRICAL CIRCUIT BREAKER DEVICE WITH OPTIMISED AUTOMATIC EXTINCTION

(71) Applicant: General Electric Technology GmbH, Baden (CH)

(72) Inventor: François BIQUEZ, Pugny-Chatenod (FR)

(21) Appl. No.: 15/534,672

(22) PCT Filed: Dec. 9, 2015
(86) PCT No.: PCT/EP2015/079125

§ 371 Date: Jun. 9, 2017

(30) Foreign Application Priority Data
Dec. 11, 2014 (FR) 1462218

(51) Int. Cl. H01H 33/95; H01H 33/74

(52) U.S. Cl. CPC H01H 33/95; H01H 33/74

(57) ABSTRACT

A self-blast electric interrupter device, such as a circuit breaker or a disconnector, the device comprising:
a first contact and a second contact that are movable between a closed position in which they press against each other, and an open position in which they are spaced apart from each other; and
an arc-control chamber surrounding the two contacts in order to define a space that is closed in the closed position.

At least one of the contacts includes a central channel opening out towards the other contact in order to enable gas coming from the arc-control chamber during an opening stage to be discharged. According to the invention, the other contact carries an insulating member that ablates under the effect of an electric arc forming in the arc-control chamber in order to give rise to a large and fast increase of pressure within the chamber.

### TECHNICAL FIELD

The invention relates to self-blast gas-insulated circuit breakers for applications at high voltages of the order of 72.5 kilovolts (kV) to 12,000 kV, where such circuit breakers are typically of the so-called “rotating-arc” type.

### STATE OF THE PRIOR ART

In an arc-control chamber containing an insulating gas such as SF₆, a gas-insulated rotating-arc circuit breaker has a coil, a first contact, and also a second contact that is movable in translation, both contacts being tubular and extending one in line with the other.

In such a circuit breaker, when an electric arc is established between the contacts as they separate during opening of the circuit breaker, the magnetic field generated by the coil gives rise to Lorentz forces (i.e. electromagnetic) forces that act on the arc in order to cause it to rotate about the axis of the circuit breaker so as to encourage extinction of the arc.

In order to further encourage extinction of the arc, in particular when a strong current is applied, the circuit breaker is provided with “self-blast” means for blasting the arc. This blast is obtained by a rise in the pressure of the insulating gas situated in a closed volume surrounding the arcing contacts at the beginning of opening, followed by the gas flowing so as to pass inside the tubular contacts that are spaced apart from each other once the instantaneous value of the alternating current comes close to zero.

The rise in pressure of the gas is nevertheless penalized by the fact that from the beginning of the circuit breaker opening the gas begins to flow in the tubular contacts. In other words, the volume surrounding the contacts and in which the gas becomes pressurized under the effect of the heating generated by the arc increases rapidly because of the contacts moving apart, thereby significantly attenuating the rise in pressure.

As can be understood, the fact that the rise in pressure is limited consequently limits the blast and thus limits the capability of the circuit breaker to extinguish the electric arc.

The object of the invention is to propose a solution that enables that drawback to be remedied.

### SUMMARY OF THE INVENTION

To this end, the invention provides a self-blast electric interrupter device, such as a circuit breaker or a disconnector, the device comprising:
a first contact and a second contact extending in line with each other, at least one of the contacts being movable in translation relative to the other contact between a closed position in which the two contacts press against each other, and an open position in which the two contacts are spaced apart from each other;
an arc-control chamber surrounding the two contacts in order to define a space that is closed when the contacts are in the closed position;
a central channel in at least one of the contacts, each central channel opening out towards the other contact while being designed to enable the gas coming from the arc-control chamber during a stage of opening the device to be discharged; and
an insulating member carried by the other contact and engaging in the channel in the closed position, this insulating member extending between the two contacts in the open position; and

wherein the insulating member is made of a material that ablates under the effect of the heat generated by an arc that becomes established between the contacts during an opening stage so as to increase the rise in pressure that occurs in the arc-control chamber in the event of such an arc appearing during a stage of opening the circuit breaker.

With this arrangement, the insulating member ablates in the event of an arc appearing during opening so as to cause pressure to rise quickly in the arc-control chamber and thus encourage rapid extinction of the arc. This member also makes it possible to delay the blast so as to obtain a greater increase in pressure in the arc-control chamber, thereby also contributing to increasing the energy of the blast.

The invention also provides a device as defined in this way, wherein the insulating member is made of a material of polytetrafluoroethylene type.

The invention also provides a device as defined in this way, wherein the insulating member is of tubular shape having holes for delaying the discharge of gas during opening of the device.

The invention also provides a device as defined in this way, wherein each of the contacts has a central channel, and both of the contacts have respective tubular bodies.

The invention also provides a device as defined in this way, wherein the insulating member includes a central wall closing off communication between its ends.

The invention also provides a device as defined in this way, wherein the insulating member is of sufficient length to keep one end engaged in the second contact including in the open position.

### BRIEF DESCRIPTION OF THE DRAWING

FIG. 1 is a fragmentary section view of a circuit breaker of the invention when closed.

FIG. 2 is a fragmentary section view of a portion of a circuit breaker of the invention when open.

### DETAILED DESCRIPTION OF PARTICULAR EMBODIMENTS

The idea on which the invention is based is to use a material that ablates under the effect of the heat generated by an electric arc, i.e. a material that sublimes under the effect of that heat so as to cause pressure to rise quickly and strongly within the arc-control chamber so as to encourage extinction of the arc.

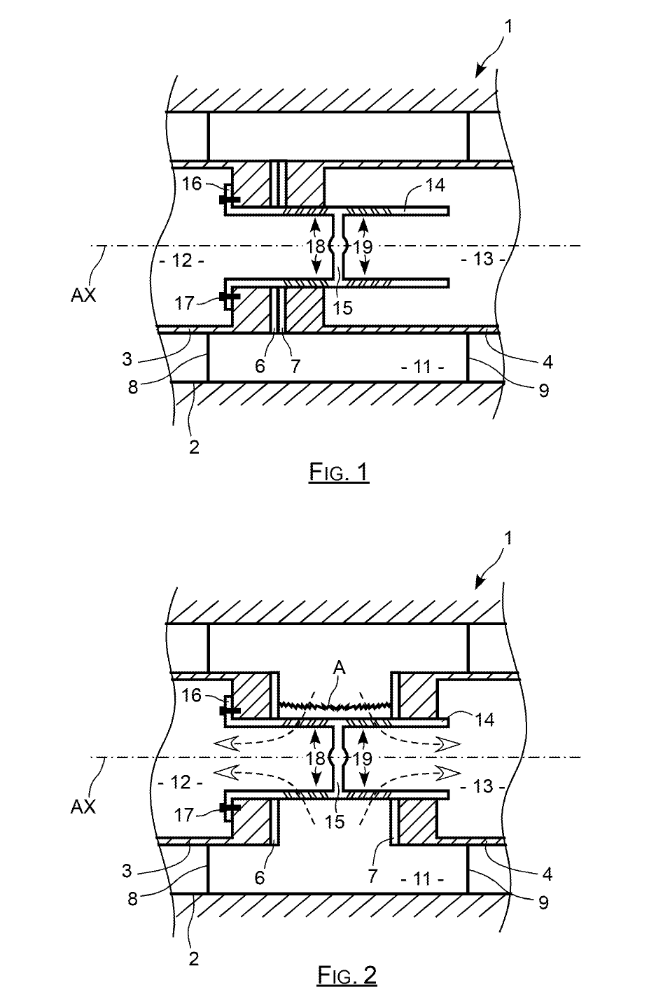

The circuit breaker 1 of the invention that is shown in FIGS. 1 and 2 comprises a main body 2 having mounted therein a first contact 3, which is stationary in this example, and a second contact 4, which is movable in this example, these contacts extending in line with each other.

In a variant, the first contact 3 could also be movable along the same axis as the contact 4 and in the opposite direction to the contact 4, these two contacts likewise extending in line with each other.

The main body 2 is in the form of a body of revolution about a longitudinal axis AX of the circuit breaker, and the first contact 3 and also the second contact 4 are also hollow elements in the form of bodies of revolution that are coaxial about the longitudinal axis AX.

The second contact 4 is movable in translation along the longitudinal axis AX between an electrically-closed position as shown in FIG. 1 and an electrically-open position, as shown in FIG. 2.

In the electrically-closed position, which corresponds to the configuration of FIG. 1, the second contact 4 has its end or contact plate 7 pressing against and in contact with the end or contact plate 6 of the first contact 3. Current can thus flow through the first and second contacts.

On the contrary, in the electrically-open position, the second contact 4 has its contact plate 7 spaced apart from the contact plate 6 of the first contact, such that the circuit breaker 1 can no longer pass an electric current.

In general, the circuit breaker is filled with dielectric gas such as SF₆, in order to improve its dielectric strength and its interrupting capability.

To this end, the main body 2 has two operator walls in its inside region in the form of rings that are oriented normally relative to the axis AX and that are referenced 8 and 9, which rings respectively surround the first contact 3 and the second contact 4 in order to define an arc-control chamber 11.

Each wall thus presents an outside diameter corresponding to the inside diameter of the body 2, and an inside diameter corresponding to the outside diameter of the first contact 3 and of the second contact 4. When the circuit breaker is closed, as shown in FIG. 1, the arc-control chamber 11 is an annular space surrounding the contacts 3 and 4 and containing insulating gas.

Each contact 3, 4 comprises a tubular body having a constricted contact end carrying a contact plate 6, 7 in the form of a ring, and defining an opening of diameter that is smaller than the diameter of the tubular body. Each hollow contact 3, 4 thus has a central channel, with these central channels being respectively referenced 12 and 13.

As can be seen in the figures, the first contact 3 carries an insulating member 14 that is engaged in the opening of its end, being rigidly fastened therein, and that is also engaged in the opening in the end of the second contact, but without being secured thereto.

The member 14 is an insulating element made of a material that ablates under the effect of heat, in particular in the event of an electric arc appearing, in order to give rise to a rapid increase of the pressure in the vicinity of the arc. By way of example, this member may be made of polytetrafluoroethylene (PTFE).

The insulating member 14 is generally tubular in shape, its outside diameter corresponding to the inside diameter of the end openings in the contacts 3 and 4. Thus, when the second contact is moved along the axis AX, it slides around the insulating member 14 in order to uncover its outside surface.

At its end situated inside the first contact 3, the insulating member has a collar 16 forming a flange that bears against the inside face of the end constriction of the first contact. By way of example, the insulating member 14 is fastened to the first contact 3 by means of screws 17 each passing through the collar 16 in order to be screwed into the end constriction.

The body of the member 14 also has an optional central wall 15 extending normally to the longitudinal axis AX and subdividing the internal channel as defined by the tubular body of this member 14 into two halves, such that these two halves do not communicate with each other.

In addition, the member 14 includes holes 18, 19 passing radially through the wall of its tubular body so as to put the arc-control chamber 11 that is situated around the member 14 into communication with each of the channels 12 and 13 as situated at respective ends of the member 14 in order to discharge the insulating gas during opening of the circuit breaker.

Because of the member 14, the blast of insulating gas present in the arc-control chamber 11 during opening of the circuit breaker is optimized so as to encourage extinction of an arc that forms between the contacts.

More particularly, during opening of the contacts while the circuit breaker is live, the second contact 4 is moved away from the first contact 3, thereby also uncovering the member 14. This movement causes an electric arc to be formed, referenced A in FIG. 2, which arc becomes established between the contact plates 6 and 7, extending longitudinally, i.e. more or less parallel to the axis AX. The member 14 thus has its outer face uncovered and in the vicinity of the electric arc that forms between the two contacts.

This arc gives rise to heating in its vicinity, such that the pressure of the gas increases inside the chamber 11. By selecting a member 14 that is made of a material that ablates, this increase in pressure is strongly emphasized: the material of the member 14 as heated by the arc sublimes so as to cause the pressure to increase more rapidly.

As the second contact 4 continues to move away from the first contact, the member continues to ablate and to cause the pressure to increase significantly so as to encourage extinction of the arc. During this process, the holes 18, 19 in the member 14 continue to be released so as to enable gas to be discharged from the arc-control chamber, i.e. so as to enable blasting to take place.

In general manner, the rapid increase of pressure in the arc-control chamber as a result of the material of the insulating member ablating enables blasting of the arc to be increased significantly in the vicinity of a zero crossing in the alternating current so as to encourage extinction of the arc. It thus serves to increase the interrupting capability of the device.

Furthermore, opening of the contacts uncovers the insulating member and also uncovers the holes so as to pass the pressurized gas so that it is discharged from the chamber 11 into the channels 12 and 13.

At the beginning of the circuit breaker opening, only a few holes 18 and 19 are released to pass gas, whereas at the end of opening, all of the holes have been released, thereby increasing the gas flow section. These holes thus themselves serve to increase the strength with which the arc A is blasted, with this blasting also being increased because of the high increase in pressure due to the ablation of the material constituting the member 14.

Since the holes 18, 19 are distributed over the surface of the member 14, blasting reaches its maximum strength at the end of opening when the arc A is at its longest, i.e. in the condition that is the most favorable for being extinguished.

The arrangement and the slope of the holes 18 and 19 in the member 14 are advantageously optimized in order to obtain the most effective arc blasting profile, given the characteristics of the arc during opening.

Thus, the closer the holes 18 and 19 to the central region of the member 14, the greater the strength of blasting at the beginning of opening. In contrast, increasing distance of the holes 18 and 19 from this central region leads to them encouraging blasting significantly at the end of opening.

These holes may also slope relative to the axis AX instead of being oriented radially so as to limit the turbulence to which they give rise in order to encourage intense blasting of the electric arc.

The central separator wall 15 in the member 14 serves to separate the streams of gas coming from the chamber 11 into one portion that is discharged into the channel 12 in the first contact 3, and another portion that is discharged into the channel 13 of the second contact 4.

In the example shown in the figures, the member 14 is of sufficient length for its end to remain engaged in the first contact once the second contact is open. Nevertheless, it could also be shorter so that its end becomes spaced apart from the second contact at the end of opening, where that would encourage a strong increase in the magnitude of blasting at the end of opening.

In general manner, the insulating member 14 serves firstly to cause pressure to increase more strongly within the arc-control chamber by the ablation effect, and secondly to delay and to adjust blasting in order to increase its effectiveness.

The gas pressure inside the chamber 11 is thus greater, and blasting has greater energy and takes place later, i.e. is more effective for extinguishing the arc.

What is claimed is:

1. A self-blast electric interrupter device (1), such as a circuit breaker (1) or a disconnector, the device comprising:
a first contact (3) and a second contact (4) extending in line with each other, at least one of the contacts being movable in translation relative to the other contact between a closed position in which the two contacts press against each other, and an open position in which the two contacts are spaced apart from each other;
an arc-control chamber (11) surrounding the two contacts in order to define a space that is closed when the contacts are in the closed position;
a central channel (12, 13) in at least one of the contacts (3, 4), each central channel (12, 13) opening out towards the other contact (3, 4) while being designed to enable the gas coming from the arc-control chamber (11) during a stage of opening the device to be discharged; and
an insulating member (14) carried by the other contact and engaging in the channel (12, 13) in the closed position, this insulating member (14) extending between the two contacts (3, 4) in the open position; and
wherein the insulating member (14) is made of a material that ablates under the effect of the heat generated by an arc (A) that becomes established between the contacts (3, 4) during an opening stage so as to increase the rise in pressure that occurs in the arc-control chamber (11) in the event of such an arc (A) appearing during a stage of opening the circuit breaker.

2. A device according to claim 1, wherein the insulating member (14) is made of a material of polytetrafluoroethylene type.

3. A device according to claim 1 wherein the insulating member (14) is of tubular shape having holes for delaying the discharge of gas during opening of the device.

4. A device according to claim 1, wherein each of the contacts (3, 4) has a central channel (14), and both of the contacts have respective tubular bodies.

5. A device according to claim 4, wherein the insulating member (14) includes a central wall (15) closing off communication between its ends.

6. A device according to claim 4, wherein the insulating member (14) is of sufficient length to keep one end engaged in the second contact (4) including in the open position.
